(19) United States
(12) Patent Application Publication
(10) Pub. No.: US 2008/0292743 A1
(43) Pub. Date: Nov. 27, 2008

(54) SHAPING DIE FOR CHIP PACKAGE LEADS

(75) Inventors: Haibo Shu, Shanghai (CN); Guangrong Pu, Shanghai (CN); Zhineng Tang, Shanghai (CN); Min Li, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: Semiconductor Manufacturing International (Shanghai) Corporation, Shanghai (CN)

(21) Appl. No.: 11/959,200

(22) Filed: Dec. 18, 2007

(30) Foreign Application Priority Data
May 21, 2007 (CN) 200710040985.0

(51) Int. Cl. B29C 33/42

(52) U.S. Cl. 425/406

(57) ABSTRACT

Disclosed herein is a shaping die for chip package leads including a base portion, on which lead pressing portions are provided, the lead pressing portions having contact portions contacting with TSOP package leads, a groove for holding the TSOP package being formed between the lead pressing portions, wherein the depth of the groove, which is the minimum distance between a location of the groove where the TSOP package is held and the contact portions of the lead pressing portions, corresponds to the maximum distance between the leads and the surface of the TSOP package held by the groove. The flatness of the shaped leads in the invention is improved and the package will not be damaged during the shaping procedure.

### CROSS-REFERENCES TO RELATED APPLICATIONS

This application claims the benefit of Chinese Application No. 200710040985.0 filed on May 21, 2007.

### STATEMENT REGARDING FEDERALLY SPONSORED RESEARCH OR DEVELOPMENT FIELD

Not applicable.

### BACKGROUND OF THE INVENTION

The present invention relates to the field of semiconductor package, and more particularly to a shaping die for Thin Small Outline Package (TSOP) leads of the chip.

TSOP is a kind of technology which involves forming pins around the chip and directly welding the pins of the packaged chip onto the surface of the Printed Circuit Board (PCB) by means of the Surface Mounting Technology (SMT). TSOP has been broadly applied since it has the advantages of high rate of finished products and lower cost and so on. In order to achieve thin small outline package in the TSOP process, the Lead On Chip (LOC) structure is commonly adopted during the plastic package process, so that after being plastic packaged the upper and lower resin layers for plastic packaging of the chip have different thickness, which in turn causes the upper and lower resin layers of the chip to be contracted differently during the cooling procedure after being plastic packaged, resulting in the warpage of the formed package.

After finishing the plastic packaging of the chip, the leads should be shaped by means of a shaping die and a punch head so as to be suitable for the mounting on the surface of PCB. FIG. 1 is a front view showing a shaping die for TSOP package leads. The shaping die 10 has a groove 11 for holding the TSOP package as shown in FIG. 1. The groove 11 is provided at its sides with lead pressing portions 12 for pressing the roots of the leads upon shaping the TSOP package leads. However, the package will be flattened when the leads of the TSOP package with warpage are shaped by the shaping die, so that the leads have been shaped in a state of the TSOP package being flattened. When removing the pressure applied to the TSOP package by the shaping die after the leads being shaped, the package will return to its warped state, which causes the coplanarity of the ends of leads contacted with other substrate or base plate (such as PCB) to be deteriorated. When the TSOP package is surface mounted on the other substrate or base plate, a part of the leads will not contact with the corresponding portion of the substrate or base plate due to the deteriorated coplanarity and broken circuit occurs.

Chinese Patent No. 02246028.4 discloses a pressing block (that is, shaping die) for shaping the leads. FIGS. 2 and 3 show the front view and left view of the pressing block for shaping disclosed in the Chinese patent, respectively. As shown in FIGS. 2 and 3, the pressing block 20 has a groove 21 and lead pressing portions 22 at the sides of the groove; the lead pressing portion 22 is provided with a concave recess 23 which corresponds to the warpage of the TSOP package leads for reducing the contact force between the lead pressing portions 22 and the leads when shaping the leads, so as to avoid deforming the leads and therefore to improve the coplanarity of the shaped leads. However, when using the pressing block for shaping the leads to shape the TSOP package leads, the pressing block tends to hurt the package and make the package broken and damaged.

### SUMMARY OF THE INVENTION

The invention provides a shaping die for chip package leads which improves the flatness of the shaped leads without damaging the package during the shaping procedure.

The shaping die for chip package leads according to the invention comprises a base portion, on which lead pressing portions are provided, the lead pressing portions having contact portions contacting with TSOP package leads, a groove for holding the TSOP package being formed between the lead pressing portions, wherein the depth of the groove, which is the minimum distance between a location of the groove where the TSOP package is held and the contact portions of the lead pressing portions, corresponds to the maximum distance between the leads and the surface of the TSOP package held by the groove.

Preferably, the depth of the groove is between 0.25 and 0.29 mm.

Preferably, the inner surface of the groove is planar.

Preferably, the inner surface of the groove has projections, the height of which is smaller than that of the pressing portions.

Preferably, the shape of the projections is one selected from a group consisting of hemisphere, part of sphere, cylinder, truncated cone, prism and frustum of prism, or a combination thereof.

Preferably, a recess is provided at the centre of the groove along a direction perpendicular to the TSOP package leads.

Preferably, the cross-section of the recess is of the shape of rectangle or arc.

Preferably, the depth of the recess is between 0.2 and 0.4 mm.

Preferably, the cross-section of the lead pressing portions is of the shape of quadrilateral or arc.

Preferably, the cross-section of the lead pressing portions is of the shape of the combination of quadrilateral and arc, and the end of the lead pressing portions is of the shape of arc.

Preferably, the cross-section of the lead pressing portions is of the shape of quadrilateral, wherein the angle between the inner surface of the groove and the side of the quadrilateral intersecting with said inner surface of the groove is between 90 and 120 degree.

Preferably, the lead pressing portion has recess.

Preferably, the shape of the recess is one selected from a group consisting of rectangle and arc, or a combination thereof.

Compared with the prior art, the solutions mentioned above have the following advantages:

The shaping die for chip package leads is designed such that the contact portions of the lead pressing portions come into contact with the leads of the TSOP package when the shaping die holds the housing of the TSOP package and the contact portions only contact with a part of the leads of the TSOP package because of the warpage of the TSOP package. The depth of the groove can ensure that when the contact portions of the lead pressing portions come into contact with the surface of the part of the leads of the TSOP package, the inner surface of the groove will touch the surface of the upper housing of the TSOP package but will not apply force thereto so that the TSOP package will not be deformed. After shaping the leads by means of a punch head and removing the shaping die for chip package leads, the shaped leads of the TSOP package have better coplanarity, so that the TSOP package using the shaping die for chip package leads according to the invention will have well electrical connection property when it is surface mounted on the PCB or other substrate, and it will not cause broken circuit.

Furthermore, when the contact portions of the lead pressing portions come into contact with the surface of the part of the leads, the inner surface of the groove will touch the surface of the upper housing of the TSOP package with warpage, which fixes the TSOP package in a fixed state. When shaping the leads of the TSOP package in combination with the lower die and the punch head, the punch head punches the leads downwardly such that the roots of the leads produce a bounce force in the upward direction which brings the TSOP package to bounce upwardly. The depth h of the groove enables the surface of the upper housing of the warped TSOP package to contact with the inner surface of the groove, which prevents the upper housing of the TSOP package from warping upwardly. This further prevents the TSOP package from bouncing upwardly and hurting the TSOP chip, which reduces the damage to the TSOP package when shaping the TSOP package leads and helps to prolong the useful life of the chip.

The provision of the recess at the center of the groove can ensure that if there is a warpage in the short-side direction of the TSOP package the warpage will be compensated, so that the TSOP package will not be deformed when the shaping die for chip lead holds and fixes the chip.

The shaping die for chip package leads according to the solution mentioned above is adapted to shape the leads of the TSOP package with not only upward warpage but also downward warpage.

### BRIEF DESCRIPTION OF THE DRAWINGS

For more complete understanding of the features and advantages of the invention described, reference is now made to a description of the invention along with accompanying Figures, wherein:

FIG. 1 is a cross-sectional schematic view of a conventional shaping die for TSOP leads;

FIGS. 2 and 3 are a front view and a left view of another conventional pressing block for shaping TSOP leads respectively;

FIG. 4 is a front view of a first embodiment of a shaping die for chip package leads according to the invention;

FIG. 5 is a left view of the first embodiment of the shaping die for chip package leads according to the invention;

FIG. 6 is a perspective view of the shaping die for chip package leads according to the first embodiment of the invention when holding a TSOP package;

FIG. 7 is a front view of the embodiment of the shaping die for leads according to the invention with projections on the inner surface of the groove;

FIG. 8 is a front view of a second embodiment of a shaping die for chip package leads according to the invention;

FIG. 9 is a left view of the second embodiment of the shaping die for chip package leads according to the invention; and

FIG. 10 is a cross-sectional schematic view of the shaping die for chip package leads according to the second embodiment of the invention when holding a TSOP package.

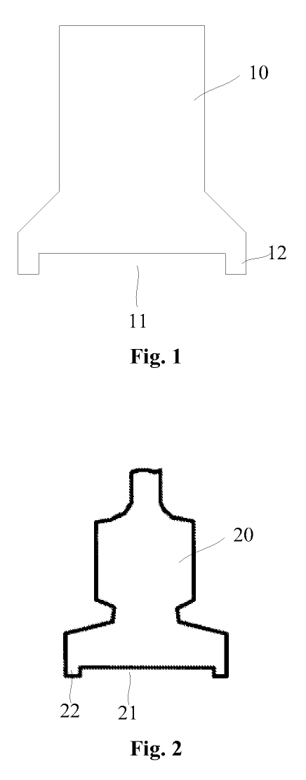

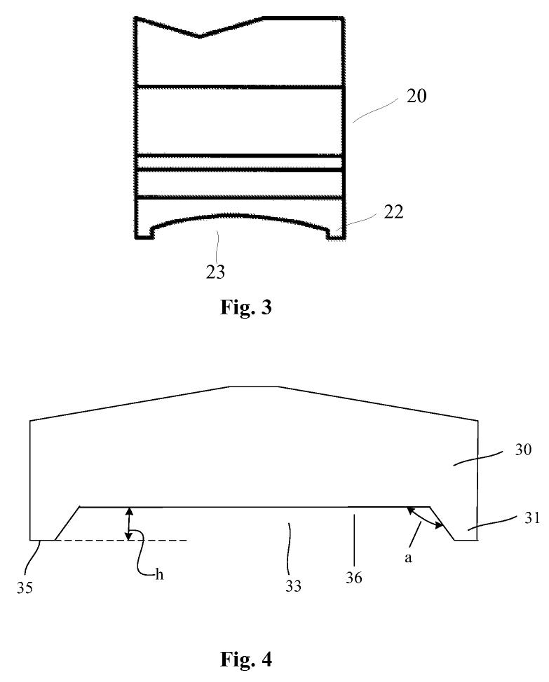

### DETAILED DESCRIPTION OF THE INVENTION

The embodiments of the invention will be described in detail with reference to the appended drawings.

In order to achieve TSOP, the LOC structure is adopted in the TSOP process, so that after the chip is plastic packaged the upper and lower resin layers of the chip have different thickness, which in turn causes the upper and lower resin layers of the chip to be contracted differently during the cooling procedure after being plastic packaged, resulting in the warpage of the formed TSOP package. The warpage causes the coplanarity of the leads to be deteriorated when the leads are shaped by a shaping die and a punch head after finishing the plastic packaging of the chip, which will further leads to a bad contact between the leads and the welding points on PCB or other substrate when the TSOP package is surface mounted on the PCB or other substrate, and even cause broken circuit therebetween, and tends to bring about electrical failure. The invention provides a shaping die for chip package leads which improves the coplanarity of the shaped leads.

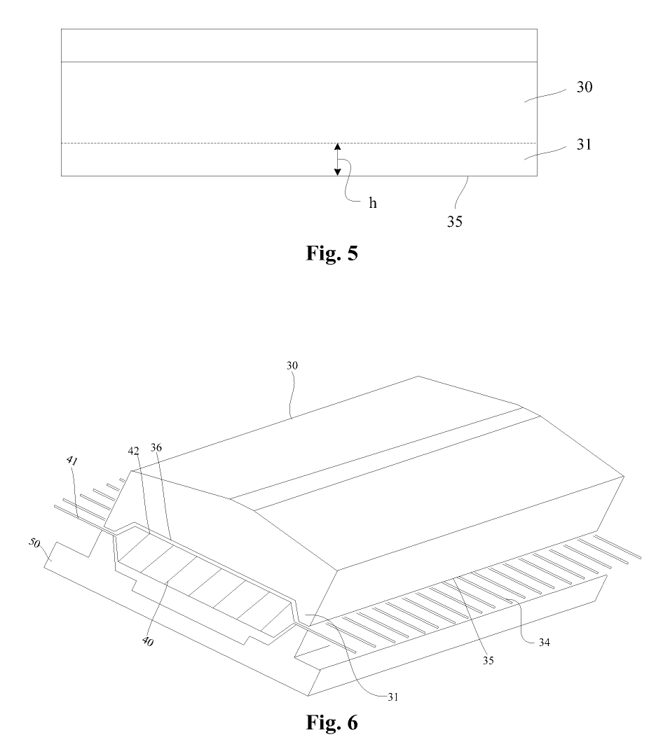

FIGS. 4 and 5 are the front view and the left view of the first embodiment of the shaping die for chip package leads according to the invention respectively.

The shaping die for chip package leads shown in FIGS. 4 and 5 comprises a base portion 30 and lead pressing portions 31 extending from the opposite sides of the base portion 30. The lead pressing portions 31 and the bottom surface of the base portion 30 define a groove 33 for holding the TSOP package. The lead pressing portions 31 have contact portions 35 contacting with the TSOP package leads.

The base portion 30 is generally made from alloy materials with higher hardness. The inner surface of the groove 33 is planar. The groove 33 is configured to hold the TSOP package when shaping the TSOP package leads. Thus, the shape of the groove 33 matches with that of the TSOP package and the lateral dimension of the groove 33 is slightly bigger than that of the TSOP package to facilitate the receiving and holding of the TSOP package. The depth h of the groove 33 corresponds to the maximum distance between the leads and the surface of the TSOP package held by the groove 33. When the TSOP package is held by the groove 33, the distance between the surface of the leads facing the contact portion 35 and the surface of the TSOP package held by the groove 33 is referred to as the distance between the leads and the surface of the TSOP package held by the groove 33. Because of the warpage of the TSOP package, the distances between the various leads of the TSOP package and the surface thereof held by the groove 33 may be different. Therefore, the depth h of the groove 33 in the present technical solution corresponds to the maximum distance among the distances between all the leads of the TSOP package and the surface of the TSOP package held by the groove 33. In the context, the depth h of the groove 33 is the minimum distance between a location of the groove 33 where the TSOP package is held and the contact portions 35 of the lead pressing portions 31, that is to say, the depth h of the groove 33 is the minimum distance between the holding surface of the groove 33 holding the TSOP package and the extension surface of the contact portions 35.

The lead pressing portions 31 are configured to press the roots of the leads of the TSOP package when the groove 33 holds the TSOP package, so as to reduce the force applied to the plastic packaged housing of the TSOP package by the roots of the leads when the leads of the TSOP package are punched using the punch head, which helps to protect the plastic packaged housing of the TSOP package and improve the strength and the useful life thereof, and protect the chip inside the TSOP package from the influence of the external force during the shaping procedure of the leads. The cross-section of the lead pressing portions 31 in the embodiment is of the shape of quadrilateral, and the angle a between the inner surface of groove 33 and the side of the quadrilateral intersecting with the said inner surface of the groove 33 is from 90 to 120 degree.

The depth h of the groove 33 in the embodiment is from 0.25 to 0.29 mm. Generally, the thicknesses of the plastic packaged housing on both sides of the TSOP package leads are different, and the thickness of the thinner plastic packaged housing on one side of the leads is normally 0.21 mm. When using the shaping die for chip package leads according to the embodiment, as shown in FIG. 6 which is the perspective schematic view of the shaping die for chip package leads according to the embodiment when holding the TSOP package 40 with upward or downward warpage, the groove 33 holds the thinner housing of the TSOP package 40, the lower die 50 holds the thicker housing of the TSOP package 40, and the supporting portions (not shown) on the lower die 50 support the leads 41 of the TSOP package 40. The contact portions 35 of the lead pressing portions 31 contact with the leads of the TSOP package 40. Since the TSOP package 40 has a warpage, the contact portions 35 only contact with a part of the leads of the TSOP package 40, such as the lead 34 shown in FIG. 6.

Furthermore, the warpage of the TSOP package causes a variation in the height difference between the highest point and the lowest point of the TSOP package in the longitudinal direction. The height difference is larger than the longitudinal thickness of the TSOP package without warpage. However, the depth of 0.25 to 0.29 mm of the groove 33 in the embodiment can ensure that when the contact portions 35 of the lead pressing portions 31 come into contact with the surface of the part of the leads 41 of the TSOP package 40, the inner surface 36 of the groove 33 will touch the housing surface 42 of the TSOP package 40 but will not apply force thereto so that the TSOP package 40 will not be deformed. After shaping the leads by means of a punch head (not shown) and removing the shaping die for chip package leads 41, the shaped leads of the TSOP package 40 have better coplanarity, so that the TSOP package 40 will have well electrical connection property when it is surface mounted on the PCB or other substrate, and it will not cause broken circuit.

Upon using the shaping die for chip package leads according to the invention to shape the leads 41 of the TSOP package 40, the inner surface 36 of the groove 33 will come into contact with the housing surface 42 of the TSOP package 40 with warpage when the contact portions 35 of the lead pressing portions 31 contact with the surface of the part of the leads 41, so that the TSOP package is in a fixed state. When shaping the leads 41 of the TSOP package 40 in combination with the lower die 50 and the punch head (not shown), the punch head punches the leads 41 downwardly such that the roots of the leads 41 produce a bounce force in the upward direction which brings the TSOP package 40 to bounce upwardly. The depth h of the groove 33 enables the housing surface 42 of the warped TSOP package 40 to contact with the inner surface 36 of the groove 33, which prevents the housing of the TSOP package 40 from warping upwardly. This further prevents the TSOP package 40 from bouncing upwardly and hurting the TSOP chip, which reduces the damage to the TSOP package 40 and helps to prolong the useful life of the chip.

In other embodiments, the cross-section of the lead pressing portions 31 can be of the shape of arc or a combination of quadrilateral and arc.

In other embodiments, the lead pressing portions 31 can also be provided with a recess which is matched with the leads of the TSOP package with warpage. The recess will not apply pressure to the leads of the TSOP package when applying the shaping die for chip package leads. The longitudinal-section of the recess can be of the shape of rectangle or arc or the combination thereof.

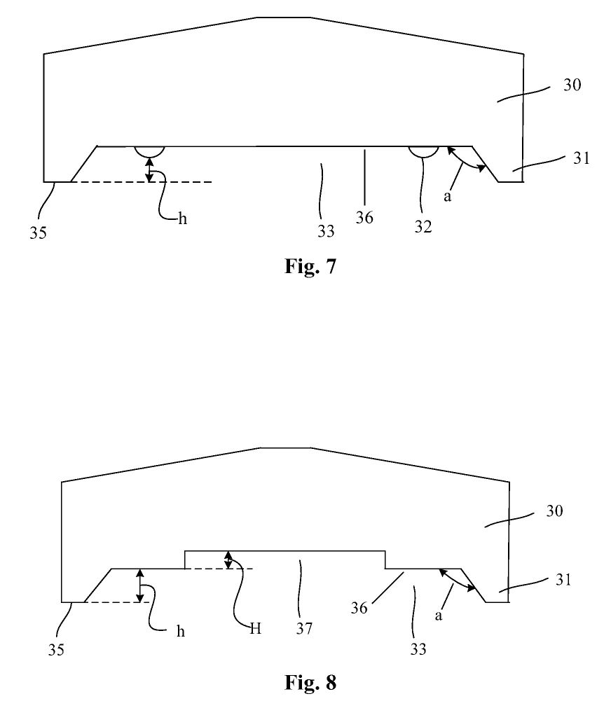

In other embodiments, projections can also be formed on the inner surface of the groove 33. As shown in FIG. 7, the groove 33 has projections 32 thereon and the height of the projections 32 is smaller than that of the pressing portions 31. In the context, the height of the projections 32 is the distance between the top ends of the projections 32 and the inner surface of the groove 33, and the height of the pressing portions 31 is the minimum distance between the extension surface of the contact portions 35 and the inner surface of the groove 33.

The depth h of the groove 33 is the minimum distance between the contact portions 35 and the top ends of the projections 32. The shape of the projections 32 can be one selected from a group consisting of hemisphere, part of sphere, cylinder, truncated cone, prism and frustum of prism, or a combination thereof. When applying the shaping die for chip package leads with the projections 32, the projections 32 will contact with the top surface 42 of the TSOP package. In other embodiments, the height of the projections 32 is adjustable.

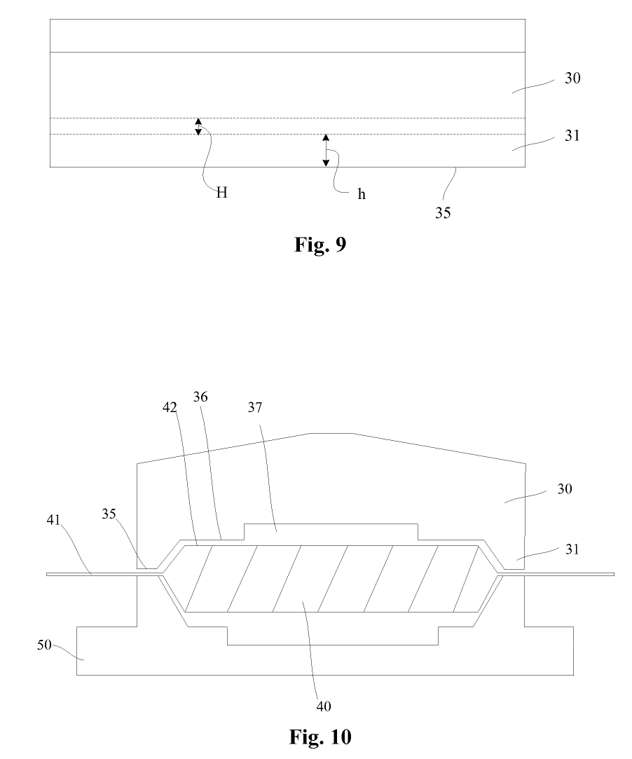

FIGS. 8 and 9 are the front view and the left view of the second embodiment of the shaping die for chip package leads according to the invention respectively.

The shaping die for chip package leads shown in FIGS. 8 and 9 comprises a base portion 30 and lead pressing portions 31 extending from the opposite sides of the base portion 30. The lead pressing portions 31 and the bottom surface of the base portion 30 define a groove 33 for holding the TSOP package. The lead pressing portions 31 have contact portions 35 contacting with the TSOP package leads.

The inner surface of the groove 33 is planar. The groove 33 is configured to hold the TSOP package when shaping the TSOP package leads. Thus, the shape of the groove 33 matches with that of the TSOP package and the lateral dimension of the groove 33 is slightly bigger than that of the TSOP package to facilitate the receiving and holding of the TSOP package. The depth h of the groove 33 corresponds to the maximum distance between the leads and the surface of the TSOP package held by the groove 33. When the TSOP package is held by the groove 33, the distance between the surface of the leads facing the contact portion 35 and the surface of the TSOP package held by the groove 33 is referred to as the distance between the leads and the surface of the TSOP package held by the groove 33. Because of the warpage of the TSOP package, the distances between the various leads of the TSOP package and the surface thereof held by the groove 33 may be different. Therefore, the depth h of the groove 33 in the present technical solution corresponds to the maximum distance among the distances between all the leads of the TSOP package and the surface of the TSOP package held by the groove 33. In the context, the depth h of the groove 33 is the minimum distance between a location of the groove 33 where the TSOP package is held and the contact portions 35 of the lead pressing portions 31, that is to say, the depth h of the groove 33 is the minimum distance between the holding surface of the groove 33 holding the TSOP package and the extension surface of the contact portions 35.

A recess 37 is provided at the center of the groove 33 along a direction perpendicular to the TSOP package leads. The cross-section of the recess 37 is of the shape of rectangle or arc. The recess 37 in this embodiment is of the shape of rectangle. The lead pressing portions 31 are configured to press the roots of the leads of the TSOP package when the groove 33 holds the TSOP package, so as to reduce the force applied to the plastic packaged housing of the TSOP package by the roots of the leads when the leads of the TSOP package are punched using the punch head, which helps to protect the plastic packaged housing of the TSOP package and improve the strength and the useful life thereof, and protect the chip inside the TSOP package from the influence of the external force during the shaping procedure of the leads. The cross-section of the lead pressing portions 31 in the embodiment is of the shape of quadrilateral, and the angle a between the inner surface of groove 33 and the side of the quadrilateral intersecting with the said inner surface of the groove 33 is from 90 to 120 degree. The depth h of the groove 33 in the embodiment is from 0.25 to 0.29 mm. As shown in FIG. 10 which is a cross-sectional view of the shaping die for chip package leads according to the embodiment when holding the TSOP package, the shaping die for chip package leads according to the embodiment can ensure that the TSOP package will not be deformed when shaping the leads of the TSOP package with warpage. The recess 37 can also ensure that if there is a warpage in the short-side direction of the TSOP package the warpage will be compensated, so that the TSOP package will not be deformed when the shaping die for chip lead according to the invention holds and fixes the chip.

In other embodiments, the cross-section of the lead pressing portions 31 can be of the shape of arc or a combination of quadrilateral and arc. In other embodiments, the lead pressing portions 31 can also be provided with a recess which is matched with the leads of the TSOP package with warpage. The recess will not apply pressure to the leads of the TSOP package when applying the shaping die for chip package leads. The longitudinal-section of the recess can be of the shape of rectangle or arc or the combination thereof.

In other embodiments, projections can also be formed on the inner surface of the groove 33. The depth h of the groove 33 is the minimum distance between the contact portions 35 and the top ends of the projections 32. The shape of the projections 32 can be one selected from a group consisting of hemisphere, part of sphere, cylinder, truncated cone, prism and frustum of prism, or a combination thereof. When applying the shaping die for chip package leads with the projections, the projections will contact with the top surface 42 of the TSOP package. In other embodiments, the height of the projections is adjustable.

While the invention has been described above by way of preferable embodiments, the invention is not limited to such embodiments. Various modifications and variations may be made to the invention without departing from the spirit and scope of the invention as set forth in the appended claims.

What is claimed is:

1. A shaping die for chip package leads comprising a base portion, on which lead pressing portions are provided, the lead pressing portions having contact portions contacting with TSOP package leads, a groove for holding the TSOP package being formed between the lead pressing portions, wherein the depth of the groove, which is the minimum distance between a location of the groove where the TSOP package is held and the contact portions of the lead pressing portions, corresponds to the maximum distance between the leads and the surface of the TSOP package held by the groove.

2. The shaping die for chip package leads according to claim 1, wherein the depth of the groove is between 0.25 and 0.29 mm.

3. The shaping die for chip package leads according to claim 1, wherein the inner surface of the groove is planar.

4. The shaping die for chip package leads according to claim 3, wherein the inner surface of the groove has projections, the height of which is smaller than that of the pressing portions.

5. The shaping die for chip package leads according to claim 4, wherein the shape of the projections is one selected from a group consisting of hemisphere, part of sphere, cylinder, truncated cone, prism and frustum of prism, or a combination thereof.

6. The shaping die for chip package leads according to claim 1, wherein a recess is provided at the centre of the groove along a direction perpendicular to the TSOP package leads.

7. The shaping die for chip package leads according to claim 6, wherein the cross-section of the recess is of the shape of rectangle or arc.

8. The shaping die for chip package leads according to claim 6, wherein the depth of the recess is between 0.2 and 0.4 mm.

9. The shaping die for chip package leads according to claim 1, wherein the cross-section of the lead pressing portions is of the shape of quadrilateral or arc.

10. The shaping die for chip package leads according to claim 1, wherein the cross-section of the lead pressing portions is of the shape of the combination of quadrilateral and arc, and the end of the lead pressing portions is of the shape of arc.

11. The shaping die for chip package leads according to claim 1, wherein the cross-section of the lead pressing portions is of the shape of quadrilateral, wherein the angle between the inner surface of the groove and the side of the quadrilateral intersecting with said inner surface of the groove is between 90 and 120 degree.

12. The shaping die for chip package leads according to claim 1, wherein the lead pressing portion has recess.

13. The shaping die for chip package leads according to claim 12, wherein the shape of the recess is one selected from a group consisting of rectangle and arc, or a combination thereof.
